(19) United States
(12) Patent Application Publication
(10) Pub. No.: US 2008/0196460 A1
(43) Pub. Date: Aug. 21, 2008

(54) INSERTABLE LOCK PLUG

(76) Inventors: Kevin Houlihan, North Salem, NY (US); Michael Gallo, Lunenburg, MA (US)

Correspondence Address: CANTOR COLBURN, LLP, 20 Church Street, 22nd Floor, Hartford, CT, 06103, US

(21) Appl. No.: 11/967,192

(22) Filed: Dec. 29, 2007

Related U.S. Application Data
(60) Provisional application No. 60/882,891, filed on Dec. 29, 2006.

(51) Int. Cl. E05B 37/00; E05B 37/08

(52) U.S. Cl. 70/285

(57) ABSTRACT

A dial assembly for a master key controlled combination lock is disclosed herein, the dial assembly having: a dial having a front side, a back side and a gripping surface disposed therebetween, the front side having an opening therein; a key plug having a lock cylinder rotatably disposed therein, the lock cylinder having a key hole end and a lever end, the lock cylinder being configured to receive a master key having a particular key code sequence in the key hole end, the key plug being configured to be installed within the dial through the opening of the dial and the lever end is configured to actuate a combination lock; and a cover plate for securing the key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the cover plate is secured to the dial by inserting the engagement portion of the cover plate in the opening until the engagement portion engages the dial.

### CROSS REFERENCE TO RELATED APPLICATIONS

This application claims the benefit of U.S. Provisional Patent Application Ser. No. 60/882,891, filed Dec. 29, 2006, the contents of which are incorporated herein by reference thereto.

### BACKGROUND

This application relates to combination locks and more particularly, to dial assemblies for combination locks.

Combination locks are used to secure or lock the door of lockers, cabinets, toolboxes, desks, and other such enclosures. In many applications, the user of the combination lock changes over time. For instance, lockers in a school are often assigned to one student user for a period of time, such as a school year, and then assigned to another student in a following school year. In this example, the school often times desires to retain the ability to gain entry to the locker without need of the combination. Thus, combination locks are provided with a master key. The master key can actuate the spring bolt to open the lock without the combination. The master key, when used with a push button mechanism, changes the combination of the lock to one of several different pre-assigned combinations.

Examples of such key-controlled combination changing permutation locks are provided in U.S. Pat. Nos. 3,023,600, 3,023,602, 3,031,876, 3,031,877, and 3,190,089 to Foote et al., the contents of which are incorporated herein by reference thereto.

Many facilities such as schools and health clubs utilize an administered locker system in which a combination lock is an integral portion of each locker. In typical configurations, the combination locks of an administered locker system employ a master keying feature configured to permit each combination lock to an be actuated into an operating position, thereby permitting supervisory access and control. In this manner, a master key having a particular key code sequence can be utilized (by, for example, a facility administrator) to open a locker without having to use the combination code for the combination lock of that locker. A master key having a particular key code sequence can also be utilized to change the combination code for a combination lock. For instance, a school administrator can change the combination code for a combination lock of a locker at the start of a new school term so a new student user of the locker will use a different combination code to access the locker than used by an earlier student user of the locker in preceding school term.

A built-in combination lock is typically installed on a locker by attaching two separate assemblies, a front dial assembly and a back case assembly. A typical dial assembly includes a dial, a dial cam disc, a key plug corresponding to a particular key code sequence, and a key plug holder. To install the lock, the dial assembly is aligned with the lock position on the front of the locker door, and screw bolts on the back side of the dial assembly are inserted through holes on the front of the locker door. Holes in the case assembly are then aligned with the screw bolts on the inside of the locker door, and the case assembly is fit into the lock position on the inside of the locker door. To complete the installation, locking nuts are placed on the screw bolts and tightened.

Administered locker systems are generally easy to administer and can provide for a high level of security. Nevertheless, over time, the components of a combination lock can tend to wear or bend, causing the lock to jam or otherwise function improperly. When these problems, as well as other issues such as tampering, vandalism, corrosion, and incorrect installation on a locker, are encountered, a replacement combination lock may be required to ensure the integrity and functionality of the locker system.

When ordering replacement combination locks and/or replacing entire locker units, facility administrators will often require that the replacement combination locks have a particular key plug that corresponds to the key code sequence being used for a set of combination locks not being replaced, for purposes of consistency. Additionally, because some administered locker systems employ a number of distinct key code sequences for a number of distinct sets of lockers that each utilize a unique key code sequence for its combination locks, facilities may require that an order for multiple replacement combination locks have key plugs corresponding to multiple distinct key code sequences.

Because dial assemblies are currently manufactured with the key plug permanently installed, the only way to ensure a particular code sequence corresponding is to specifically order that sequence, which tends to lead to a rather long delivery time. Alternatively and in order to provide a quick delivery or stock time, a lock suppliers must maintain larger than desired inventories of dial assemblies to be able to immediately satisfy customer requests for particular models of combination locks and particular key code sequences at any given time. That is, to ensure that customers will not have to wait for an order corresponding to a particular built-in combination lock case assembly and/or a particular key code sequence, a manufacturer must maintain a stock of dial assemblies for each model that corresponds to each key code sequence. For instance, if a company were to manufacture dial assemblies for 6 different models of built-in combination locks and have 25 different corresponding key code sequences available for each model, that company would be required to stock 300 different dial assemblies to ensure that a dial assembly corresponding to a particular combination lock model corresponding and a particular key code sequence ordered by a customer would be in stock at the time of the order.

Accordingly, it is desirable to provide a dial assembly for built-in combination locks that allows for a manufacturer to have an inventory of combination lock components that can be utilized across a broad customer base, wherein a particular key code sequence ordered by a customer will be in stock at the time of the order.

### SUMMARY

In one exemplary embodiment, a dial assembly for a master key controlled combination lock is disclosed herein, the dial assembly having: a dial having a front side, a back side and a gripping surface disposed therebetween, the front side having an opening therein; a key plug having a lock cylinder rotatably disposed therein, the lock cylinder having a key hole end and a lever end, the lock cylinder being configured to receive a master key having a particular key code sequence in the key hole end, the key plug being configured to be installed within the dial through the opening of the dial and the lever end is configured to actuate a combination lock; and a cover plate for securing the key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the cover plate is secured to the dial by inserting the engagement portion of the cover plate in the opening until the engagement portion engages the dial.

In another exemplary embodiment, a method of inserting a master key plug in a dial of a combination lock is provided, the method comprising: inserting a master key plug into an opening on a front side of the dial, the master key plug further comprising a key plug and a lock cylinder rotatably disposed in the key plug, the lock cylinder having a key hole end and a lever end, the master key plug being configured to receive a master key having a particular key code sequence in the key hole end, wherein insertion of the master key in the lock cylinder will allow the lock cylinder to rotate within the key plug, the lever end being disposed opposite to the key hole end and is configured to actuate the combination lock; and inserting a cover plate into the opening of the dial, the cover plate securing the master key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the engagement portion of the cover plate is inserted into the opening of the dial until the engagement portion engages the dial.

In still another exemplary embodiment a combination lock is provided, the combination lock comprising: an enclosure having a bolt extending therefrom; and a dial assembly removably secured to the enclosure and for retracting the bolt into the enclosure, the dial assembly comprising: a dial having a front side, a back side and a gripping surface disposed therebetween, the front side having an opening therein; a key plug having a lock cylinder rotatably disposed therein, the lock cylinder having a key hole end and a lever end, the lock cylinder being configured to receive a master key having a particular key code sequence in the key hole end, the key plug being configured to be installed within the dial through the opening of the dial and the lever end is configured to actuate a combination lock; and a cover plate for securing the key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the cover plate is secured to the dial by inserting the engagement portion of the cover plate in the opening until the engagement portion engages the dial.

### BRIEF DESCRIPTION OF THE DRAWINGS

FIGS. 1 and 2 are exploded perspective views of an exemplary embodiment of the present invention;

FIG. 3 illustrates a partial perspective cross-sectional view of the operation of an exemplary embodiment of a tumbler locking mechanism that can be utilized in the exemplary dial assembly of FIGS. 1 and 2;

FIG. 4 illustrates an exemplary embodiment of a key plug holder that can be utilized in the exemplary dial assembly of FIGS. 1 and 2;

FIG. 5 is a rear view of an exemplary embodiment of a dial housing utilizing the exemplary key plug holder of FIG. 4;

FIG. 6 illustrates an exemplary embodiment of a cam disc that can be utilized in the exemplary dial assembly of FIGS. 1 and 2;

FIG. 7 is a rear view of an exemplary embodiment of a dial housing utilizing the exemplary cam disc of FIG. 6;

FIG. 8 illustrates a front view of an exemplary embodiment of the present invention; and

FIG. 9 illustrates a side view of an exemplary embodiment of the present invention secured to a combination lock case assembly.

### DETAILED DESCRIPTION OF EXEMPLARY EMBODIMENTS

Exemplary embodiments of the present invention are directed to a dial assembly for a built-in master key controlled combination lock.

The dial assembly includes a dial, a key plug, and a cover plate. The key plug has a lock cylinder configured to receive a master key having a particular key code sequence for actuating a combination lock mechanism (e.g., rotation of the lock cylinder in the lock plug when the correct key is inserted therein). In one non-limiting exemplary embodiment, a dial assembly is provided that can be assembled and mounted on a case assembly having a lock mechanism such that rotation of the lock cylinder of the key plug can actuate the lock mechanism to retract a lock bolt extending therefrom and place the lock mechanism in an unlocked state. In another non-limiting exemplary embodiment, a dial assembly is provided that can be assembled and mounted on a case assembly having a combination lock mechanism such that rotation of the lock cylinder of the key plug can actuate the lock mechanism to an operating position so that a preset combination code of the combination lock can be changed. A dial assembly in accordance with these examples could be installed as part of a combination lock that is built-in or integral with a school or health club locker.

In accordance with an exemplary embodiment of the present invention, an exemplary embodiment of a dial assembly can be configured to be installed with a plurality of models of combination locks. The dial assembly can further be configured so the key plug is one of the last components installed as part of a combination lock. For example, installation of the key plug can occur after the dial assembly housing has been installed on a locker and/or mounted to a combination lock case assembly or the key plug is the last item installed in the dial assembly. Because the key plug can be configured for installation in a plurality of models of dial assembly housings that correspond to a plurality of distinct models of combination locks, inventories of the key plugs can be maintained separately from inventories of dial assembly housings. Consequently, a manufacturer of combination locks need only maintain an inventory of key plugs for each key sequence and, separately, a dial assembly housing for each combination lock model. That is, the manufacturer need not maintain an inventory of dial assemblies for each model corresponding to each key code sequence. This enables the manufacturer to minimize inventory levels of combination lock components.

Non-limiting examples of combination changing permutation locks contemplated for use with exemplary embodiments of the present invention are shown in U.S. Pat. Nos. 3,023,600, 3,023,602, 3,031,876, 3,031,877, and 3,190,089, the contents each of which are incorporated herein by reference thereto.

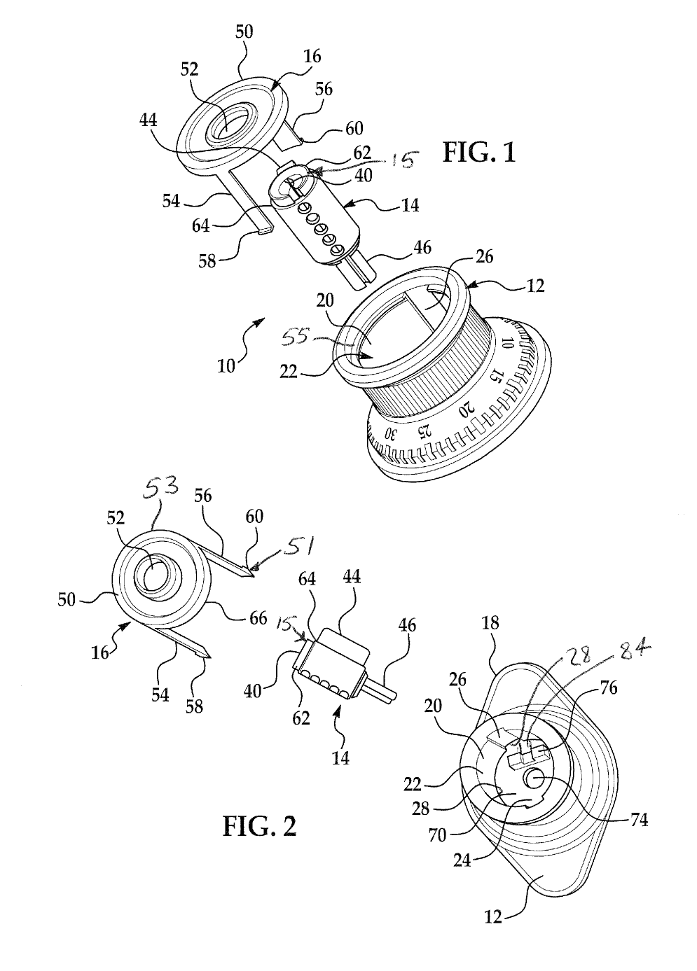

In accordance with an exemplary embodiment of the present invention, an exemplary embodiment of a dial assembly is illustrated in FIGS. 1 and 2. Dial assembly 10 includes a dial or dial housing 12, a key plug or master key plug 14, and a cover plate 16. In the exemplary embodiment shown, dial housing 12 includes a protective and/or ornamental escutcheon plate 18 surrounding the edges of the dial housing. As is known in the related arts the dial is rotatably secured to the escutcheon plate through insertion of the dial through the back side of the escutcheon plate and securement of the same to the escutcheon plate such that the dial can rotate but cannot be removed from the escutcheon plate. In one non-limiting embodiment, the escutcheon plate has an opening with a rim portion that allows the dial to be inserted therein however, the larger diameter portion of the back side of the dial prevents the same from completely passing through the opening in the escutcheon plate. In addition, the dial has an edge or periphery configured to rotate within the rim or opening of the escutcheon plate.

Dial or dial housing 12 is configured to receive key plug 14 and retain a portion of cover plate 16 for securing the key plug within the dial housing. In an exemplary embodiment, dial housing 12 includes a retaining portion configured receive an engagement portion of cover plate 16 for securing the cover plate to the dial housing. Dial housing 12 includes a surface 20 defining an opening 22 configured to receive key plug 14 therein. As best seen in FIG. 2, the retaining portion of dial housing 12 has a first slot 24, a second slot 26, and a ledge, engagement feature or retaining portion 28. First slot 24, second slot 26, and ledge 28 are configured engage portions of cover plate 16 to secure the cover plate to the dial housing.

The lock cylinder of the key plug 14 is configured to receive a master key having a particular key code sequence, which in turn allows the same to be rotated therein when the correct master key is inserted therein. The key plug can thus be configured so that, when part of an assembled dial assembly has been properly mounted to a suitable combination lock case assembly, insertion and rotation of a master key having the particular key code sequence in the key plug can place the lock mechanism of the case assembly in an unlocked position without needing to use the dial assembly to dial a combination code associated with the combination lock using the dial assembly.

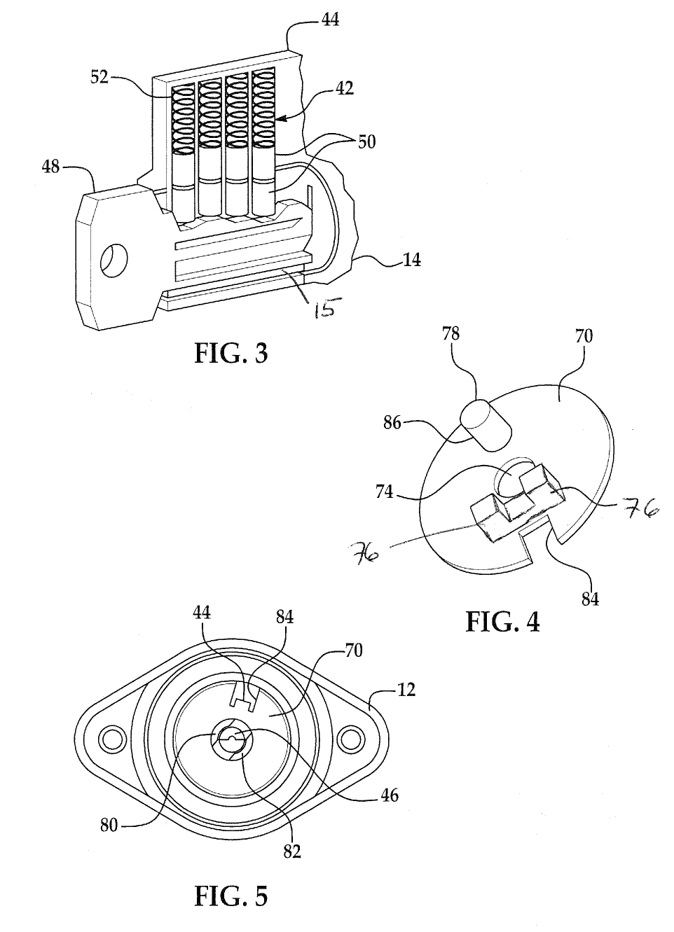

In the exemplary embodiment illustrated in FIGS. 1-3, key plug 14 includes: a lock cylinder 15 having a keyhole 40 at one end and an engagement feature or lever 46 at the other end and extending from the lock plug; a pin-tumbler mechanism 42 for allowing selective rotation of the lock cylinder in the key plug when a master key matching the pin-tumbler mechanism is inserted in the key hole; and a positioning member 44 extending an exterior surface of the lock plug. Positioning member 44 is configured to engage another portion of the dial assembly to fix a position of the key plug within the dial housing, as will be described in greater detail with respect to the exemplary embodiment illustrated in FIGS. 4 and 5 below. Keyhole 40 and pin-tumbler mechanism 42 (illustrated in FIG. 3) are configured to receive a master key having a particular key code sequence, which when received will allow rotational movement of the lock cylinder and the engagement member.

An exemplary embodiment of the action of pin-tumbler mechanism 42 of key plug 14 is illustrated in detail in FIG. 3. Pin-tumbler mechanism 42 corresponds to a particular key code sequence and includes a plurality of pins 50 of varying lengths and/or shapes, as well as a plurality of springs 52. When a master key 48 having the particular key code sequence is disposed in keyhole 40, the plurality of pins align in manner to allow a central portion or the lock cylinder of the key plug to be rotated relative to a fixed portion (such as positioning member 44) of the key plug. In one exemplary embodiment, in response to rotation of master key 48 within keyhole 40 and when the dial assembly is assembled onto a combination lock case assembly, pin-tumbler mechanism 42 allows rotational movement of the lock cylinder which in turn induces rotational movement of engagement lever 46 that actuates the combination lock to an unlocked position. In another exemplary embodiment, in response to insertion of master key 48 within keyhole 40 when the dial assembly is assembled onto a combination lock case assembly, pin- tumbler mechanism 42 allows rotational movement of the lock cylinder which in turn induces rotational movement engagement lever 46 that actuates the combination lock into an operating position such that a combination code that is presently recognizable by the combination lock can then be changed.

Referring again to the exemplary embodiment illustrated in FIGS. 1 and 2, cover plate 16 is configured to be secured to dial housing 12 thus securing key plug 14 within the dial housing. In one exemplary embodiment, cover plate 16 includes a substantially plate shaped portion 50 and an engagement portion 51 configured to secure the cover plate to dial housing 12. Plate portion 50 includes an inner aperture 52 configured to rotationally receive a portion of lock cylinder therein. In one non-limiting exemplary embodiment, the engagement portion of cover plate 16 comprises a first leg 54 and a second leg 56. Each of first and second legs 54, 56 extend away from plate portion 50. First leg 54 is also spaced apart from second leg 56. As best seen in FIG. 2, first leg 54 is configured to be slidably received within first slot 24 of the dial housing and second leg 56 is configured to be slidably received within second slot 26 of the dial housing.

First leg 54 includes a catch 58 that angularly extends away from the first leg. Second leg 56 includes a catch 60 that angularly extends away from the second leg. First catch 58 and second catch 60 are each configured to frictionally engage ledge or engagement feature 28 of dial housing 12 when first and second legs 54, 56 of the cover plate are inserted into opening 22 of the dial housing. First leg 54 is biased so that catch 58 abruptly moves in an outward direction to engage ledge 28 for securing the cover plate to the dial housing. Similarly, second leg 56 is biased so that catch 60 abruptly moves in an outward direction to engage ledge 28 for securing the cover plate to the dial housing. In an alternative exemplary embodiment, ledge or engagement feature 28 can be replaced with a pair of retaining surfaces, wherein each catch engages one of the pair of retaining surfaces for securing the cover plate to the dial housing. In accordance with an exemplary embodiment of the present invention ledge or engagement feature 28 is positioned to provide a surface or feature that the engagement portion or catch (58, 60) can engage when the cover plate is inserted therein. In other words, the engagement feature or ledge will be positioned away from surface 20 of the surface of the holding plate or plug holder 70 so that the engagement portion of the cover plate can engage the complimentary feature of the dial.

As illustrated in FIG. 2, the engagement portion is configured to secure cover plate 16 to dial housing 12 in a predetermined orientation for structural, aesthetic, and/or other reasons. In exemplary embodiments, first leg 54 can have a different configuration than second leg 56. For example, first leg 54 can be wider than second leg 56. In this example, first slot 24 of dial housing 12 would be configured complementarily to first leg 54 to slidably receive the wider first leg thus, providing a means to correctly orientate the plate portion in the opening in the dial.

When cover plate 16 is secured to dial housing 12, first leg 54 aligns with first slot 24 and second leg 56 aligns with second slot 26. As first and second legs 54, 56 are inserted within opening 22 during assembly, first catch 58 slides against a surface of first slot 24 and second catch 60 slides against a surface of second slot 26. When first catch 58 and second catch 60 reach ledge 28, the first catch and the second catch abruptly move in an outward direction so that each catch frictionally engages the ledge. When catches 58 and 60 engage ledge 28, the cover plate is secured to and cannot thereafter be separated from the dial housing. In addition, a peripheral portion 53 is received on a ledge portion 55 of opening 22 so that cover plate does not pass too far into opening 22 and an outer surface is correctly positioned with an front surface of the dial (e.g., flush, slightly recessed or slightly protruding from the dial surface).

In accordance with exemplary embodiments of the present invention the engagement portion can have anyone of a variety of features as long as the engagement portion engages a portion of the dial such that once inserted from the front side of the dial the cover cannot be removed from the front of the dial and is thus permanently secured therein for security reasons (e.g., lock cannot be tamper with from the front of the dial). In non-limiting alternative exemplary embodiments, the engagement portion of the cover plate may have one leg with one catch or more than two legs with catches and the legs in any of these embodiments may extend all the way to ledge 28 at the back side of the dial or the ledge may be anywhere in the surface 20 of opening 22 and the legs may have different lengths and/or widths with respect to each other. In accordance with an exemplary embodiment of the present invention the engagement portion of the cover plate is configured to provide a “snap in” attachment of the cover plate to the dial or dial assembly thus providing ease of assembly of the lock plug therein.

Of course, the cover plate and engagement portion may be configured to be removed from the back side of the dial assembly if the dial assembly is removed from the lock mechanism. In one exemplary embodiment, this would be achieved by accessing the back side of the dial and overcoming the biasing force of the engagement portion through the use of a tool so that the cover plate can be removed from the dial through the front side. Thus, exemplary embodiments of the present invention allow the dial assembly to be removed from the lock and the master cylinder or lock plug can be replaced or if an assembler incorrectly inserts the wrong lock plug it can be removed as long as the back side of the dial assembly is accessible. This does not create a security issue since the back side of the dial is not accessible when installed in a contemplated use (e.g., lockers etc.). Of course, the cover plate and dial can be configured so that once the cover plate is installed the same cannot be removed from the dial once inserted therein and when the engagement portion engages the dial.

In accordance with an exemplary embodiment of the present invention the cover plate is formed from an easily molded material such as plastic or alternatively a metal or metal alloy. In accordance with an exemplary embodiment of the present invention, the legs are integrally formed with the cover plate and comprise a material that causes them to be biased outwardly towards the inner surface of the opening in the dial such that one engaged in an engagement feature of the dial the cover plate is permanently secured therein. In other words, the legs or engagement members must be biased inward to insert the same within the opening of the dial and when the engagement members (e.g., catch or other equivalent feature) aligns with the retaining feature (e.g., ledge or other equivalent feature) they will spring or bias into the feature and snap fit or secure the cover plate and the plug to the dial.

Upon installation of key plug 14 within dial housing 12, installation of cover plate 16 within dial housing 12 acts to secure the key plug within the opening of the dial housing. As shown in the exemplary embodiment of FIGS. 1 and 2, inner aperture 52 of the cover plate is configured to rotationally receive a protruding portion 62 of the lock cylinder. The protruding portion is configured to be rotationally held by a surface that defines inner aperture 52 while a surface 64 of the key plug abuts against an inner surface 66 of the cover plate. When the dial assembly has been assembled, key plug 14 is held by cover plate 16 so that a master key may be inserted through inner aperture 52 and into keyhole 40 of the lock cylinder to actuate the pin-tumbler mechanism and rotate the lock cylinder to provide the desired functions (e.g., open lock or change combination).

In an alternative exemplary embodiment, the protruding portion is integrally formed with the lock plug and remains fixed within aperture 52 and the lock cylinder is rotationally received within the lock plug and the key hole of the lock cylinder is accessed through aperture 52 and rotated when a master key is inserted therein. In any of these configurations, aperture 52 locates the lock plug at the front of the dial and allows for the master key to access the key hole and rotate the lock cylinder to provide the desired functions (e.g., open lock or change combination).

In an exemplary embodiment, a plug holder and optionally a dial cam disc are installed into the dial housing. As illustrated in FIGS. 4-7, a plug holder or holding plate 70 and a cam disc 72 are utilized with dial assembly 10 of FIGS. 1 and 2. Plug holder 70 is provided for holding key plug 14 in a substantially fixed position within the dial housing. As seen in the exemplary embodiment illustrated in FIG. 4, plug holder 70 is substantially plate shaped and includes a center aperture 74, a channel-shaped guide member 76, a bottom guide member 78, and a pair of rear-guide members 80 and 82 (illustrated in FIG. 5).

Center aperture 74 is configured to receive engagement lever 46 of the lock cylinder during installation of the key plug into dial housing 12. Channel-shaped guide member 76 protrudes away from the plate portion and is configured so at least a portion of positioning member 44 of key plug 14 is received between leg portions of the channel-shaped guide member. In accordance with exemplary embodiments of the present invention the channel guide member may have numerous configurations as long as it retains a feature of the key plug therein. For example, the channel guide member may be flush with a surface of the plug holder or may extend or be recessed with respect to the surface of the plug holder. As shown in FIG. 2, channel-shaped guide member 76 faces toward an interior portion of dial housing 12 when plug holder 14 is installed within the dial housing. In one non-limiting exemplary embodiment, plug holder 70 is further configured to include an opening 84 positioned in the plate portion of the plug holder. Opening 84 is provided to aid in disposing positioning member 44 of the key plug between leg portions of channel-shaped guide member 76 during assembly of the dial assembly for example, opening 84 may provide a means for viewing that member 44 is in guide member 76.

Bottom guide member 78 includes a chamfered surface 86 configured so a portion of the key plug rests on the chamfered surface when the key plug is secured within the dial housing thus, the key plug is supported on at least two sides by features of the plug holder. Rear-guide members 80 and 82 are configured to guide engagement lever 46 therebetween when the engagement lever extends through center aperture 74 of the plug holder. In addition, the rear guide members are also used for dialing combinations by rotating the dial assembly wherein the rear guide members engage complimentary features of the combination lock. Rear-guide members are further configured to center the cam disc about the engagement lever when the cam disc is installed within the dial housing.

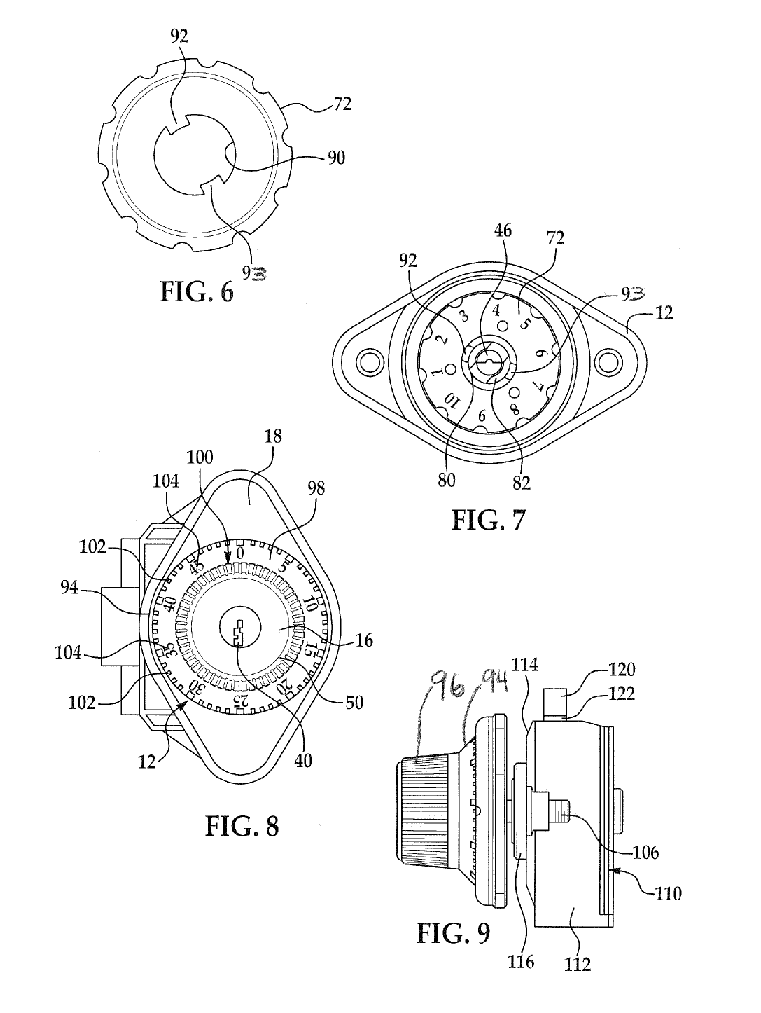

As seen in the exemplary embodiment illustrated in FIG. 6, cam disc 72 is substantially plate shaped and includes a center aperture 90 and a pair of guide members 92, 93. Cam disc 72 is configured to be secured against a surface of dial housing 12 when the dial assembly is assembled so that plug holder 70 is held within the dial housing between cover plate 16 and the cam disc, as seen in the exemplary embodiment illustrated in FIG. 7. When the cam disc is installed within the dial housing, engagement lever 46 of key plug 14 extends through center aperture 90 and between guide members 92, 93 of the cam disc. After the key plug and plug holder have been installed within the dial housing, the cam disc can be secured to the dial housing using any suitable means. For example, the cam disc can be crimped to a portion of the dial housing. When the dial assembly is assembled and mounted to a combination lock case assembly, the cam disc can rotate with a portion of the combination lock so that a combination code sequence can be used to open the combination lock.

In accordance with an exemplary embodiment of the present invention, a dial assembly can be assembled from a dial assembly of a type described in relation to the exemplary embodiments above by, first, installing a key plug of the type described that corresponds to a particular key code sequence into a dial housing of the type described. Following this step, a cover plate of the type described can be installed into the dial housing, thereby securing the key plug into the dial housing. The key plug installed can be selected from a plurality of key plugs based the desired corresponding key code sequence, and can be installed within a dial housing model selected from a number of models each corresponding to a particular combination lock case assembly. By maintaining a stock of key plugs for each corresponding key code sequence and a stock of dial housings for each lock model type, as well as a suitable stock of cover plates, a company can maintain an inventory of dial assemblies that can be assembled into dial assemblies for all combinations of key code sequences and combination lock model types that may comprise a customer order using less total components. That is because it would thus not be necessary to maintain an inventory of actual dial assemblies corresponding to each possible combination. In other words, only the key plug with the discrete master key combination needs to be installed into the front opening of a dial assembly thus the dials may be immediately customized for a particular customer by keying a master cylinder or lock plug and then snapping it into the dial assembly, which comprises existing stock since they can be used in many applications since it is only the master cylinder or lock plug that needs to be specifically prepared for a customer. In the past, the entire dial assembly had to be ordered with the particular master key code and thus, a customer has to typically wait longer since it would be economically inefficient to have dial assemblies with integral master key codes since each customer order would require a distinct master key code.

In accordance with an exemplary embodiment of the present invention, a method of distributing a dial assembly from a pre-manufactured inventory is provided. In this exemplary method, a customer first place an order for a dial assembly for a master key controlled combination lock. In response to this order, a dial housing, a key plug, and a cover plate, examples of which can correspond to the type described in relation to the exemplary embodiment of FIG. 1 and 2, are assembled at a factory and are distributed to the customer. Alternatively, they can be shipped unassembled to the customer wherein the cover plate and the key plug are merely snapped into place though the opening in the front side of the lock.

In the present exemplary method, the key plug distributed to the customer can be selected to be a pre-manufactured lock cylinder having a keyhole end configured to receive a master key having a key code sequence that is specified prior to being selected for distribution to the customer. A pre-manufactured inventory of key plugs with lock cylinders having a keyhole end configured to receive a master key having a particular key code sequence can exist for each distinct key code sequence of a plurality of key code sequences. Thus, the selection of the key plug can be made from these inventories. For example, the key code sequence of the selected key plug can be specified in the customer order or correspond to a particular school district identifier. The key code sequence of the selected key plug can also be specified based upon availability for usage of a master key having the specified key code sequence and optimization of the pre-manufactured inventories of key plugs. For example, availability for usage of a master key having the specified key code sequence can be determined based upon whether a master key having the specified key code sequence is already in use in a geographical area corresponding to a location of the customer placing the customer order. In certain embodiments, duplication of a master key in the same geographical area for different customers can be prohibited. In exemplary embodiments, the customer order can also specify a model type for the dial housing from a plurality of pre-manufactured model types for each of which a stock of inventory is maintained.

The dial assembly can be distributed to the customer either as an assembled dial assembly or an unassembled package. Further, the dial assembly can be distributed to the customer with the dial housing being mounted on a locker door and secured to a combination lock case assembly. When distributed mounted on a locker door, the dial housing can be part of an assembled dial assembly, or part of an unassembled package, in which case a key plug and a cover plate would be distributed to the customer as separate components. Moreover, the dial housing, or the entire dial assembly, can first be distributed to a locker manufacturer for mounting prior to distribution to the customer.

In accordance with an exemplary embodiment of the present invention, an assembled dial assembly is illustrated in FIG. 8. A dial assembly 100 is shown having a key plug (with only keyhole 40 being shown) installed within a dial housing 12 and secured to the dial housing by a cover plate 16. The cover plate, a plate shaped portion 50 of which is shown with keyhole 40 being received within an aperture 52, is secured within the dial housing. Dial housing 12 includes a disc dial portion 94 that is integrally rotatable with a knob portion 96. Disc dial portion 94 is annular and tapers outwardly from the front of the dial housing. Knob 96 has a substantially truncated cylindrical or conical shape and projects outwardly from the disc dial portion. Disc dial portion 94 has a larger diameter than knob portion 96. A front dial face 98 of the disc dial portion includes formed radial dial markings 102 and numerical indicia 104 adjacent to periodic dial markings.

A cam disc (not shown) is installed within the back side of dial housing 12 and positioned concentrically with the axis of rotation of disc dial portion 94 and knob portion 96. The cam disc is configured to interact with the disc dial portion and knob portion to rotate with respect to rotation of the disc dial portion and knob portions. Screw bolts 106 (only one of which is shown) extend from the back of dial housing 12.

An exemplary embodiment of a case assembly for use with the exemplary assembled dial assemblies described above is illustrated in FIG. 9. A case assembly 110 is shown having a lock housing 112 and a front plate 1 14. A lock mechanism (not shown) is installed within the lock housing behind the front plate. In accordance with an exemplary embodiment of the present invention the lock mechanism may be similar to any of those illustrated in U.S. Pat. Nos. 3,023,600, 3,023,602, 3,031,876, 3,031,877, and 3,190,089, the contents of which are incorporated herein by reference thereto.

As shown, a lock bolt 120 is extendable from the lock mechanism through a lock bolt aperture 122 in lock housing 112. Lock bolt 120 is extendable to, for example, engage behind a strike in a locker frame to secure a locker door in a locked state, and lock bolt 120 is retractable to, for example, place the locker door in an unlocked state.

Front plate 114 has screw apertures 116 for engaging with the screw bolts extending from a dial assembly through a locker door, as will be described below. In addition, front plate 114 has an engagement aperture in which a dial assembly can engage the lock mechanism installed within the case assembly and thereby actuate the lock mechanism. Examples of lock mechanisms for use in exemplary case assemblies can include vertical dead bolt mechanisms, horizontal dead bolt mechanisms, spring latch mechanisms, and lift latch mechanisms.

In accordance with the present invention, an exemplary embodiment of a dial assembly installed with a case assembly 110 on a locker door. Dial assembly 100 is aligned with the lock position on the front of a locker door, and screw bolts on the back side of the dial assembly are inserted through holes on the front of the locker door. Screw holes in case assembly 110 are also aligned with the screw bolts on the inside of the locker door, and the case assembly is fit into the lock position on the inside of the locker door. Locking nuts are placed on the screw bolts and tightened. The locker door is thus located between the dial assembly and the case assembly.

In an exemplary embodiment, case assembly 110 has a lock mechanism having a lock bolt 120. The lock bolt is extendable from a lock housing 112 to engage behind a strike (not shown) in a locker frame and secure the locker door in a locked state, and retractable to place the locker door in an unlocked state.

Dial assembly 100 includes a dial housing 12, a cover plate 16, and a key plug (with only keyhole 40 being shown) installed within the dial housing and secured to the dial housing by the cover plate. Cover plate 16 is secured within the dial housing and includes a plate shaped portion 50 having an aperture 52 with keyhole 40 being received therein. Keyhole 40 is configured to receive a master key having a particular key code sequence. The lock cylinder is rotatable upon insertion of such a master key into the keyhole. The lock cylinder further has an engagement lever that interacts with the lock mechanism of case assembly 110 through an aperture in locker door wherein rotation of the lock cylinder using a master key that causes the engagement lever to actuate the lock mechanism to both extend lock bolt 120 to either place the door in a locked state and retract the lock bolt to place the door in an unlocked state.

Dial housing 12 further includes a disc dial portion 94 that is integrally rotatable with a knob portion 96. Disc dial portion 94 is annular and tapers outwardly from the front of the dial housing. Knob 96 has a substantially truncated cylindrical or conical shape and projects outwardly from the disc dial portion. Disc dial portion 94 has a larger diameter than knob 96. A front dial face 98 of the disc dial portion includes formed radial dial markings 102 and numerical indicia 104 adjacent to periodic dial markings.

In one exemplary embodiment, a cam disc is installed within the back side of dial housing 12 and positioned concentrically with the axis of rotation of disc dial portion 94 and knob portion 96. The cam disc is configured to interact with the disc dial portion and knob portion to rotate with respect to rotation of the disc dial portion and knob portion. The cam disc interacts with the lock mechanism of case assembly 110 through the engagement aperture in locker door such that rotation of the cam disc actuates the lock mechanism to retract lock bolt 120 to place the locker door in an unlocked state upon recognition by the lock mechanism of a sequential rotation of the disc dial portion and knob portion in alternating fashion to a pre-set sequence of numerals of numerical indicia 104 on the disc dial portion. In exemplary embodiments, the pre-set sequence of numerals can include a three-digit numerical sequence.

In exemplary embodiments, the pre-set sequence of numerals can correspond to a presently designated permutation of a series of alternate permutations recognizable by the lock mechanism. In addition, a button can extend from the lock housing that can be used to change the present designated permutation to another permutation recognizable by the lock mechanism. For example, the present permutation can be moved sequentially through the series of alternate permutations by rotating the key plug with a master key while at the same time pushing the button extending from the case assembly housing. In this manner, a locker system administrator, such as one in a school or a health club, can change the combination code on a combination lock when the corresponding locker unit is assigned to another user.

Exemplary embodiments of the dial assembly can be configured to be mounted with any suitable combination lock case assembly type and any suitable locker type. Examples of suitable locker types include left-hand opening lockers, right-hand opening lockers, left-hand reverse opening lockers, and right-hand reverse opening lockers. Examples of suitable materials for a locker include metals, wire mesh, woods, and durable plastics. In exemplary embodiments in which a dial assembly is to be mounted on a wood locker, it is preferable that the dial assembly include an escutcheon plate that is composed of brass.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. It should also be noted that the terms “first”, “second”, and “third” and the like may be used herein to modify elements performing similar and/or analogous functions. These modifiers do not imply a spatial, sequential, or hierarchical order to the modified elements unless specifically stated.

What is claimed is:

1. A dial assembly for a master key controlled combination lock, the dial assembly comprising:
a dial having a front side, a back side and a gripping surface disposed therebetween, the front side having an opening therein;
a key plug having a lock cylinder rotatably disposed therein, the lock cylinder having a key hole end and a lever end, the lock cylinder being configured to receive a master key having a particular key code sequence in the key hole end, the key plug being configured to be installed within the dial through the opening of the dial and the lever end is configured to actuate a combination lock; and
a cover plate for securing the key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the cover plate is secured to the dial by inserting the engagement portion of the cover plate in the opening until the engagement portion engages the dial.

2. The dial assembly as in claim 1, wherein the dial further comprises a retaining portion and the engagement portion of the cover plate further comprises a pair of legs extending from the face portion and spaced apart from each other, each of the pair of legs having a catch angularly extending away from each of the pair of legs, each catch being configured to engage the retaining portion of the dial for securing the cover plate to the dial.

3. The dial assembly as in claim 1, further comprising a key plug holder disc installed within the back side of the dial, the key plug further comprises a positioning member extending from a periphery of the key plug, the positioning member being configured to engage the key plug holder disc for fixing a position of the key plug when the key plug is installed within the dial assembly housing.

4. The dial assembly as in claim 1, wherein the back side of the dial fixedly and rotatably secured to an escutcheon plate, the escutcheon plate being configured to mount the dial assembly to a housing of the combination lock and the key plug further includes a tumbler lock mechanism corresponding to a particular key code sequence.

5. The dial assembly as in claim 1, wherein the dial further comprises a pair of slots disposed in an inner surface of the opening of the dial and each of the pair of slots further comprises a ledge disposed at the back side of the dial and the engagement portion of the cover plate further comprises a pair of legs extending from the face portion of the cover plate, the pair of legs being spaced apart from each other and each of the pair of legs has a catch configured to engage ledge when the cover plate is inserted in the opening of the dial and the pair of legs are received in the pair of slots and a peripheral portion of the face portion is received on a ledge portion of the opening in the dial.

6. The dial assembly as in claim 1, wherein the gripping surface comprises an integrally rotatable disc dial portion and a knob, the disc dial portion being annular and outwardly tapering from the back side of the dial and the knob portion having a substantially truncated cylindrical or conical shape and projecting outwardly from the disc dial portion toward the front side of the dial, the disc dial portion having a larger diameter than the knob portion.

7. The dial assembly as in claim 6, further comprising a plug holder secured to the back side of the dial, the plug holder having a guide member for receiving a positioning member of the key plug when the key plug is inserted within the opening of the dial, the guide member preventing rotation of the key plug when the positioning member is received within the guide member.

8. The dial assembly as in claim 7, further comprising a cam disc installed within the back side of the dial and positioned concentrically with the axis of rotation of the disc dial portion and the knob portion, the cam disc interacting with the disc dial portion to rotate with respect to rotation of the disc dial portion, the cam disc having a center aperture, the center aperture permitting the lever end of the lock cylinder to extend therethrough.

9. The dial assembly as in claim 8, wherein sequential rotation of the disc dial portion and knob portion in alternating fashion to a pre-set sequence of numerals of numerical indicia disposed on the disc dial portion rotates the cam disc to actuate the combination lock and wherein the pre-set sequence of numerals corresponds to a present permutation of a series of alternate permutations recognizable by the lock mechanism.

10. The dial assembly as in claim 1, wherein the dial further comprises a pair of slots disposed in an inner surface of the opening of the dial and each of the pair of slots further comprises a ledge disposed at the back side of the dial and the engagement portion of the cover plate further comprises a pair of legs extending from the face portion of the cover plate, the pair of legs being spaced apart from each other and each of the pair of legs has a catch configured to engage the ledge when the cover plate is inserted in the opening of the dial and the pair of legs are received in the pair of slots.

11. The dial assembly as in claim 1, wherein at least the pair of legs are formed from a resilient material and the pair of legs are biased into a position wherein the catch of each leg will engage the ledge when the cover plate is inserted into the opening of the dial.

12. A method of inserting a master key plug in a dial of a combination lock, the method comprising:
inserting a master key plug into an opening on a front side of the dial, the master key plug further comprising a key plug and a lock cylinder rotatably disposed in the key plug, the lock cylinder having a key hole end and am engagement lever end, the master key plug being configured to receive a master key having a particular key code sequence in the key hole end, wherein insertion of the master key in the lock cylinder will allow the lock cylinder to rotate within the key plug, the lever end being disposed opposite to the key hole end and is configured to actuate the combination lock; and
inserting a cover plate into the opening of the dial, the cover plate securing the master key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the engagement portion of the cover plate is inserted into the opening of the dial until the engagement portion engages the dial.

13. The method as in claim 12, wherein the dial further comprises a retaining portion and the engagement portion of the cover plate further comprises a pair of legs extending from the face portion and spaced apart from each other, each of the pair of legs having a catch angularly extending away from each of the pair of legs, each catch being configured to engage the retaining portion of the dial for securing the cover plate to the dial.

14. The method as in claim 12, wherein the dial assembly further comprises a key plug holder disc installed within the back side of the dial and the key plug further comprises a positioning member extending from a periphery of the key plug, the positioning member being configured to engage the key plug holder disc for fixing a position of the key plug when the key plug is installed within the dial assembly housing.

15. The method as in claim 12, wherein the back side of the dial is fixedly and rotatably secured to an escutcheon plate, the escutcheon plate being configured to mount the dial assembly to a housing of the combination lock.

16. The method as in claim 12, wherein the dial further comprises a pair of slots disposed in an inner surface of the opening of the dial and each of the pair of slots further comprises a ledge disposed at the back side of the dial and the engagement portion of the cover plate further comprises a pair of legs extending from the face portion of the cover plate, the pair of legs being spaced apart from each other and each of the pair of legs has a catch configured to engage the ledge when the cover plate is inserted in the opening of the dial and the pair of legs are received in the pair of slots.

17. A combination lock, comprising:
an enclosure having a bolt extending therefrom; and
a dial assembly removably secured to the enclosure and for retracting the bolt into the enclosure, the dial assembly comprising:
a dial having a front side, a back side and a gripping surface disposed therebetween, the front side having an opening therein;
a key plug having a lock cylinder rotatably disposed therein, the lock cylinder having a key hole end and a lever end, the lock cylinder being configured to receive a master key having a particular key code sequence in the key hole end, the key plug being configured to be installed within the dial through the opening of the dial and the lever end is configured to actuate a combination lock; and
a cover plate for securing the key plug in the dial, the cover plate having a face portion and an engagement portion, the face portion having an aperture extending therethrough, the aperture being configured to rotatably receive the keyhole end of the lock cylinder therein and the engagement portion is configured to secure the face portion in the opening of the dial when the cover plate is secured to the dial by inserting the engagement portion of the cover plate in the opening until the engagement portion engages the dial.

18. The combination lock as in claim 17, further comprising a plug holder secured to the back side of the dial, the plug holder having a guide member for receiving a positioning member of the key plug when the key plug is inserted within the opening of the dial, the guide member preventing rotation of the key plug when the positioning member is received within the guide member.

19. The combination lock as in claim 17, wherein the dial further comprises a pair of slots disposed in an inner surface of the opening of the dial and each of the pair of slots further comprises a ledge disposed at the back side of the dial and the engagement portion of the cover plate further comprises a pair of legs extending from the face portion of the cover plate, the pair of legs being spaced apart from each other and each of the pair of legs has a catch configured to engage the ledge when the cover plate is inserted in the opening of the dial and the pair of legs are received in the pair of slots.

20. The combination lock as in claim 19, wherein at least the pair of legs are formed from a resilient material and the pair of legs are biased into a position wherein the catch of each leg will engage the ledge when the cover plate is inserted into the opening of the dial.
